(19) United States
(12) Patent Application Publication
(10) Pub. No.: US 2020/0117632 A1
(43) Pub. Date: Apr. 16, 2020

(54) METHOD FOR COMMUNICATING BETWEEN A MICROCONTROLLER AND A TRANSCEIVER COMPONENT, MICROCONTROLLER, AND TRANSCEIVER COMPONENT

(71) Applicant: Robert Bosch GmbH, Stuttgart (DE)

(72) Inventors: Arthur Mutter, Neuhausen (DE); Florian Hartwich, Reutlingen (DE); Steffen Walker, Reutlingen (DE)

(21) Appl. No.: 16/618,451

(22) PCT Filed: May 24, 2018
(86) PCT No.: PCT/EP2018/063616

§ 371 Date: Dec. 2, 2019

(30) Foreign Application Priority Data
Jun. 2, 2017 (DE) 10 2017 209 435.4

(51) Int. Cl. G06F 13/42; H04L 12/40; H04L 29/06; G06F 21/44; G06F 13/40

(52) U.S. Cl. CPC G06F 13/42; H04L 12/40032; H04L 63/0435; H04L 2012/40215; G06F 21/44; G06F 13/409; H04L 63/083

(57) ABSTRACT

A transceiver component, according to a transfer protocol: receives output for a bus at an input connected to a first pin of a microcontroller; and transmits input for the microcontroller from the bus to an output connected to a second pin of the microcontroller. A transceiver: receives the output from the input and transmits it via the bus; and receives the input from the bus and transmits it via the output. According to the protocol, the transceiver component: receives data for a function, that a device of the transceiver component is designed to perform, via the input; and/or transmits data for the function via the output. The transceiver component includes a bus controller that includes: a communication input that is connectable to an output of the transceiver for receiving the data; and/or a communication output that is connectable to another input of the transceiver for transmitting the data.

### CROSS-REFERENCE TO RELATED APPLICATIONS

The present application is the national stage of International Pat. App. No. PCT/EP2018/063616 filed May 24, 2018, and claims priority under 35 U.S.C. § 119 to DE 10 2017 209 435.4, filed in the Federal Republic of Germany on Jun. 2, 2017, the content of each of which are incorporated herein by reference in their entireties.

### FIELD OF THE INVENTION

The present invention relates to a method for communicating between a microcontroller and a transceiver component. Moreover, the present invention relates to a microcontroller, a transceiver component, and a computer program that are designed to carry out this method.

### BACKGROUND

Conventional microcontrollers transmit data via a transceiver component which is designed to transmit the data via a data bus. For example, according to the ISO 11898-2 standard, in CAN transceiver components, two pins of the microcontroller are used for the communication between a CAN controller in the microcontroller and a CAN transceiver in the CAN transceiver component. A CAN controller is a circuit or implementation that operates according to the ISO 11898-1:2015 standard. This type of CAN controller is integrated into conventional microcontrollers that communicate via a CAN bus. A first pin, TxD, is used to transfer data from the microcontroller to the CAN transceiver. A second pin, RxD, is used to transfer data from the CAN transceiver to the CAN controller. The CAN transceiver fulfills a CAN transceiver functionality. The CAN transceiver functionality encompasses the CAN transceiver generating on the CAN bus signal level for the transmission of data that are transferred via the first pin, TxD. The CAN transceiver functionality encompasses the CAN transceiver component detecting on the CAN bus signal level for the reception of data that are transferred via the second pin, RxD. A typical form of housing for CAN transceivers is S08, which is a housing with 8 pins. CAN transceiver components which in addition to the CAN transceiver functionality also contain an additional function, for example partial networking or a firewall, are accommodated in housings that include more pins. In general, at least one further pin is provided in addition to the first pin, TxD, and the second pin, RxD. The reason is that the additional function must be configured, or that the additional function requires communication with the microcontroller. The at least one further pin is used for communicating between the CAN transceiver component and the microcontroller.

One example of a CAN transceiver component, TJA1145 from NXP, is situated in a housing with 14 pins. Four of these pins are necessary for a serial peripheral interface, which is used for communicating between the CAN transceiver component and the microcontroller.

### SUMMARY

It is desirable to use fewer pins for communicating between the microcontroller and the transceiver component.

According to an example embodiment, a transceiver component is designed to at least intermittently receive output data for a data bus at a first input of the transceiver component according to a transfer protocol, the first input being designed for connection to a first pin of a microcontroller, the transceiver component being designed to at least intermittently transmit input data for the microcontroller from the data bus to a first output of the transceiver component according to the transfer protocol, the first output being designed for connection to a second pin of the microcontroller, the transceiver component including a transceiver that is designed to at least intermittently receive the output data from the first input and transmit them via the data bus, the transceiver being designed to at least intermittently receive input data from the data bus and transmit them via the first output, the transceiver component including an additional functional device that is designed to carry out an additional function, the transceiver component being designed to at least intermittently receive additional data for the additional function via the first input according to the transfer protocol, and/or to at least intermittently transmit additional data for the additional function via the first output according to the transfer protocol, the transceiver component including a first transceiver bus controller, the first transceiver bus controller including a first communication input that is connectable to an output of the transceiver for receiving the additional data, and/or the first transceiver bus controller including a first communication output that is connectable to a second input of the transceiver for transmitting the additional data. The transfer protocol specifies the sequences at the interface between the microcontroller and the transceiver component, via which a transfer of the additional data is possible using the same pins that are used for the normal bus operation of the microcontroller. This saves on pins at the microcontroller and at the transceiver component, since no additional pins are needed for communicating with the additional function. The first transceiver bus controller can thus receive additional data at the first input and/or transmit additional data at the first output. The transceiver component is thus compatible with any microcontroller that includes an appropriate bus controller. For example, CAN controllers are used as bus controllers.

The first transceiver bus controller preferably includes a second communication input that is connectable to the first input for authenticating the microcontroller. An authentication of the microcontroller by the transceiver is thus possible.

The transceiver component is preferably designed to receive a first message containing an identifier, to store the received identifier in a nonvolatile memory, to read the stored identifier from the nonvolatile memory, and to transmit a second message, containing the read identifier, on the data bus. This allows the transceiver component to provide an identifier that is usable for communicating between the transceiver component and the microcontroller.

The transceiver component is preferably designed to generate an identifier, and to transmit the identifier in a first message on the data bus. This allows an identifier to be provided on the transceiver component which is usable for communicating between the transceiver component and the microcontroller.

The transceiver component is preferably designed to exchange a symmetrical cryptographic key with the microcontroller or some other node on the data bus, and to use the symmetrical cryptographic key for a cryptographic authentication or encryption of at least one message to be transmitted, and/or to use the symmetrical cryptographic key for a cryptographic authentication or decryption of at least one received message. This allows a secure communication.

The transceiver component preferably includes a second transceiver bus controller that is designed to transmit at least one message or partial message according to the transfer protocol via an external data bus, the transceiver component including a first logic component that is designed to selectively allow or prevent a transfer of the additional data or the at least one message or partial message on the external data bus, the first transceiver bus controller being designed to control the second transceiver bus controller and/or the first logic component in order to at least intermittently transmit the at least one message or partial message on the external data bus, while the first transceiver bus controller receives the additional data via the first input. This masks the transmission of the additional data on the data bus.

The transceiver component preferably includes a second logic component that is designed to selectively allow or prevent a transfer of the input data or the additional data at the first output, the first transceiver bus controller being designed to control the second logic component in order to transfer either the input data or the additional data. A transmission of the additional data separately from the input data is thus made possible.

With regard to the method for communication, it is provided that output data for a data bus are at least intermittently received at a first input of a transceiver component according to a transfer protocol, the first input being designed for the connection to a first pin of a microcontroller, input data for the microcontroller being at least intermittently transmitted from the data bus to a first output of the transceiver component according to the transfer protocol, the first output being designed for the connection to a second pin of the microcontroller, a transceiver receiving at least the output data from the first input and transmitting them via the data bus, the transceiver at least intermittently receiving the input data from the data bus and transmitting them via the first output, an additional function being carried out in an additional function device in the transceiver component, additional data for the additional function being at least intermittently received via the first input according to the transfer protocol, and/or additional data for the additional function being at least intermittently transmitted via the first output according to the transfer protocol, a first communication input of a first transceiver bus controller being at least intermittently connected to an output of the transceiver for receiving the additional data, and/or a first communication output of the first transceiver bus controller being at least intermittently connected to a second input of the transceiver for transmitting the additional data. This method is very easy to use. The method saves on pins at the microcontroller and at the transceiver component, since it requires no additional pins for communicating with the additional function.

A second communication input of the first transceiver bus controller for authenticating the microcontroller is advantageously connected to the first input.

A first message is advantageously received which contains an identifier, the received identifier is stored in a nonvolatile memory, the stored identifier is read from the nonvolatile memory, and a second message containing the read identifier is transmitted on the data bus. An identifier of the transceiver component is thus provided to the transceiver component and then used for future messages with which additional data, intended for the transceiver component, are transferred.

An identifier is preferably generated, and the identifier is transmitted in a first message on the data bus. An identifier of the transceiver component is thus generated by the transceiver component itself and provided to the microcontroller for future messages with which additional data, intended for the transceiver component, are transferred.

A symmetrical cryptographic key is preferably exchanged with the microcontroller or some other node on the data bus, the symmetrical cryptographic key being used for a cryptographic authentication or encryption of at least one message to be transmitted, and/or the symmetrical cryptographic key being used for a cryptographic authentication or decryption of at least one received message. The communication between the transceiver component and the microcontroller is therefore secure.

The communication device preferably transmits at least one message or partial message according to the transfer protocol via an external data bus, a transfer of the additional data or of the at least one message or partial message on the external data bus being selectively made possible, the at least one message or partial message being at least intermittently transmitted on the external data bus, while the additional data are received via the first input. The additional data on the data bus are thus masked by the at least one message or partial message. Other nodes on the data bus thus learn which additional data are transmitted.

Either the input data or the additional data are preferably selectively transferred at the first output. The transceiver component thus transmits additional data separately from the input data.

According to an example embodiment, a computer program is designed to carry out this method.

Further example embodiments result from the following description and the drawings.

### BRIEF DESCRIPTION OF THE DRAWINGS

FIG. 1 schematically shows portions of a first example embodiment of an interface between a microcontroller and a transceiver component.

FIG. 2 schematically shows portions of a second example embodiment of the interface between the microcontroller and a transceiver component.

FIG. 3 schematically shows an example signal-time diagram for the second example embodiment of the interface.

### DETAILED DESCRIPTION

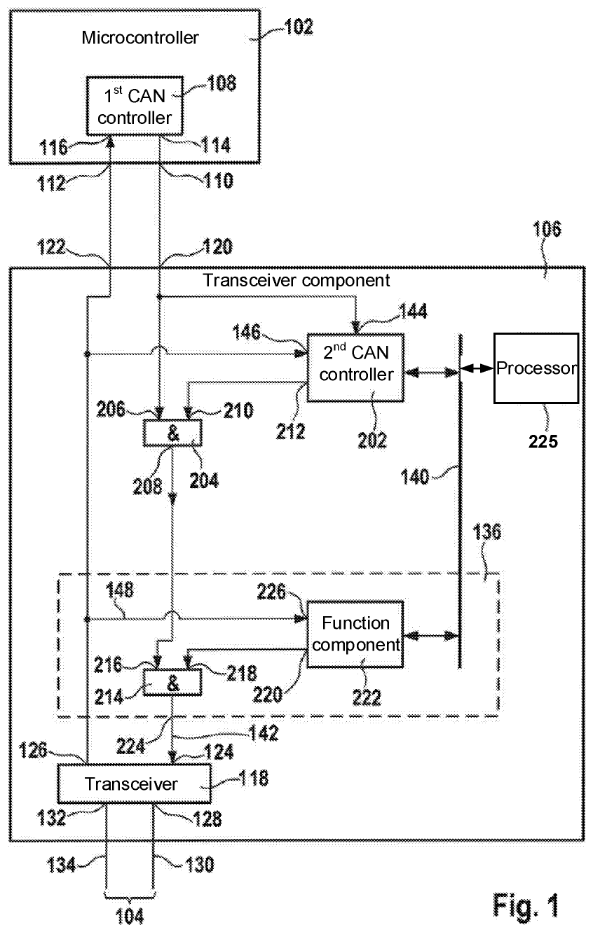

FIG. 1 schematically shows portions of a connection of a microcontroller 102 to a data bus 104. More precisely, microcontroller 102 is connected to data bus 104 via a transceiver component 106.

Microcontroller 102 includes a bus controller 108. Bus controller 108 is a CAN controller, for example, that is designed to operate according to the ISO 11898-1:2015 standard.

Microcontroller 102 includes a first pin 110 for transmitting output data from microcontroller 102 to transceiver component 106. Microcontroller 102 includes a second pin 112 for receiving input data from transceiver component 106. Bus controller 108 includes a first output 114 that is connected to first pin 110. Bus controller 108 includes a first input 116 that is connected to second pin 112.

Transceiver component 106 includes a transceiver 118. Transceiver 118 is a CAN transceiver, for example, that is designed to operate according to the ISO 11898-2:2016 standard. Transceiver component 106 includes a third pin 120 for receiving output data that are transferred from microcontroller 102 to transceiver component 106. Transceiver component 106 includes a fourth pin 122 for transmitting input data that are transferred from transceiver component 106 to microcontroller 102. Transceiver 118 includes a second input 124 that is connected to third pin 120. Transceiver 118 includes a second output 126 that is connected to fourth pin 122.

Transceiver 118 includes a first contact 128 that is connected to data bus 104 via a first signal line 130. First signal line 130 connects, for example, transceiver 118 to CAN high. Transceiver 118 includes a second contact 132 that is connected to data bus 104 via a second signal line 134. Second signal line 134 connects, for example, transceiver 118 to CAN low.

First pin 110 and third pin 120 are at least intermittently connected for transferring output data. Second pin 112 and fourth pin 122 are at least intermittently connected for transferring input data.

Transceiver component 106 includes an additional function device 136. In the example, additional function device 136 is connected to a system bus 140. Additional function device 136 is connected to transceiver 118 via at least one electrical line 142.

Transceiver component 106 includes a first communication input 146 and a second communication input 144. First communication input 146 is at least intermittently connected to fourth pin 122 and second output 126. Second communication input 144 is at least intermittently connected to third pin 120 and second input 124.

Microcontroller 102 and transceiver component 106 are designed to transfer additional data. In the example, bus controller 108 is designed to transfer the additional data. In the example, transceiver component 106 includes at least one corresponding bus controller that is designed to transfer the additional data. The additional data, the input data, and the output data are preferably transferred using the same transfer protocol. In the example, a transfer protocol corresponding to the ISO 11898 standard family is used. The additional data are transferred by transmitting the additional data either from microcontroller 102 to transceiver component 106, or from transceiver component 106 to microcontroller 102, as described below. The additional data are preferably not transferred via data bus 104.

Two embodiments of an interface between microcontroller 102 and transceiver component 106 are described below.

FIG. 1 schematically shows portions of a first embodiment of the interface between microcontroller 102 and transceiver component 106. In the first embodiment of the interface, transceiver component 106 includes a first transceiver bus controller 202. In the first embodiment of the interface, transceiver component 106 includes a first logic component 204. In the example, first logic component 204 is a first AND gate and is referred to below as first AND gate 204. First AND gate 204 includes a first signal input 206 that is connected to third pin 120. First AND gate 204 includes a first signal output 208 that is connectable to second input 124 via additional function device 136. First AND gate 204 includes a second signal input 210 that is connected to a first communication output 212 of transceiver bus controller 202.

In the example, additional function device 136 includes a second logic component 214. In the example, second logic component 214 is a second AND gate and is referred to below as second AND gate 214. Second AND gate 214 includes a third signal input 216 that is connected to first signal output 208. Second AND gate 214 includes a fourth signal input 218 that is connected to a function output 220 of a function component 222 of additional function device 136. Second AND gate 214 includes a second signal output 224 that is connected to second input 124 via first electrical line 142.

In the example, a function input 226 of function component 222 is connected to second output 126 of transceiver 118 via a second electrical line 148.

First AND gate 204 is designed, for example, to output an overlap of its two inputs as a logical AND operation at first signal output 208. Second AND gate 214 is designed, for example, to output an overlap of its two inputs as a logical AND operation at second signal output 224.

System bus 140 connects first transceiver bus controller 202 and function component 222. System bus 140 is connected to a processor 225 that controls system bus 140, first transceiver bus controller 202, and function component 222 as follows.

In the example, first transceiver bus controller 202 is a second CAN controller that is designed to operate according to the ISO 11898-1:2015 standard. The first CAN controller and the second CAN controller are also designed to implement the communication method described below.

The second CAN controller is an equivalent user on the CAN bus. Microcontroller 102 and transceiver component 106 communicate with each other via the CAN bus. According to the first embodiment of the interface, the first CAN controller and the second CAN controller communicate. Processor 225 is a CPU or a comparable controller, for example, that controls an additional function that is implemented on function component 136, based on messages, more precisely frames, that are exchanged using the first CAN controller and the second CAN controller.

The first CAN controller and the second CAN controller are configured as follows.

Bit Timing Configuration

The second CAN controller uses a bit timing (BT) configuration that is compatible with the BT configurations of the other users on the CAN Bus, in particular the first CAN controller.

The following variants for the configuration of the BT are conceivable:

Transceiver component 106 contains a preconfigured BT, for example 500 kbit/s. This BT configuration is known to microcontroller 102. Microcontroller 102 uses this BT for the communication. Microcontroller 102 can subsequently change the BT configuration of transceiver component 106 via the existing communication channel.

Transceiver component 106 contains multiple preconfigured BTs, and tries them out in sequence.

In the case of CAN FD according to ISO 11898-1, for example, with bit rate switching, the first communication, for example, takes place without bit rate switching. If the communication is successful, microcontroller 102 can communicate the BT configuration to transceiver component 106 for the case with bit rate switching.

Frame ID for the Communication

The second CAN controller and the first CAN controller establish CAN frame IDs and use them for communicating with one another.

A CAN frame ID that is used for communicating between transceiver component 106 and microcontroller 102 is referred to below as a communication frame ID (KFID). CAN frames with a KFID are referred to below as communication frames (KFs).

Possible variants for establishing the KFID:

The KFID is statically configured in transceiver component 106.

The KFID is dynamically communicated during switch-on. For example, during switch-on the KFID is transferred from microcontroller 102 to transceiver component 106, or vice versa.

For example, microcontroller 102 transfers the KFID to be used to transceiver component 106, in that transceiver component 106 reads at least one CAN frame transmitted from microcontroller 102, and then configuring the KFID.

For example, the frame ID of the first CAN message that is sent from microcontroller 102 is used as a KFID. Beginning at this point in time, transceiver component 106 can communicate with microcontroller 102 via this KFID, using CAN messages.

For example, the KFID is alternatively or additionally ascertained from the following information:

The KFID is derived from arbitrary portions of a CAN frame that is transmitted from microcontroller 102.

The KFID is derived from a combination of portions of a CAN frame that is transmitted from microcontroller 102, for example from a data field. A frame ID of a message that is transmitted from microcontroller 102 is used as the KFID.

A combination of these options is likewise conceivable.

For example, a message that contains the KFID information is recognized as follows:

Transceiver component 106 recognizes a configuration frame (KF), containing the KFID, at an ID that is fixedly configured in transceiver component 106, for example static 0x3FF.

Transceiver component 106 knows that the Nth CAN frame transmitted from microcontroller 102 is the KF.

Utilizing the KFID

If only one KFID is utilized, the situation must be avoided that transceiver component 106 and microcontroller 102 simultaneously transmit the KFID, since this is not allowed according to CAN transfer protocol. A simple approach here is for microcontroller 102 and transceiver component 106 to continually transfer in alternation one CAN frame together with the KFID.

If two KFIDs are utilized, microcontroller 102 and transceiver component 106 each include a unique KFID. This has an advantage that microcontroller 102 and transceiver component 106 can transmit independently of one another.

If more than two KFIDs are utilized, microcontroller 102 and/or transceiver component 106 can include multiple unique KFIDs. This can be helpful for communicating with transceiver component 106.

For example, microcontroller 102 receives two unique KFIDs, a first KFID with low priority on the CAN bus, and a second KFID with high priority. Microcontroller 102 uses one of the two KFIDs, depending on the priority of the information to be transferred to the second CAN controller.

Authentication Between Transceiver Component 106 and Microcontroller 102

One of the following authentications can optionally be provided:

Case 1: Transceiver component 106 trusts only its own node, i.e., microcontroller 102.

For example, the second CAN controller in transceiver component 106 trusts only microcontroller 102, which is connected to transceiver component 106 using TxD pins, i.e., using first pin 114, and RxD pins, i.e., using second pin 116. This means that the second CAN controller stores a KF only if it has been transmitted from microcontroller 102. Transceiver component 106 recognizes frames that microcontroller 102 transmits, in that transceiver component 106 observes first input 120, i.e., thus also observes the TxD pin of microcontroller 102 that is directly connected. The major advantage is that this measure is very simple compared to cryptographic measures. For example, for this purpose, second communication input 144 of first transceiver bus controller 202 is connectable to first input 120 for authenticating microcontroller 102.

Case 2: Transceiver component 106 trusts one or multiple node(s) on the CAN bus.

The second CAN controller is a full user on the CAN Bus. The second CAN controller uses, for example, cryptographic methods (signing, encryption) to ensure the authenticity of a frame or to mask the contents of the frame. For example, transceiver component 106 additionally includes a “plug-and-secure configuration for CAN” module. In this case, via one or multiple node(s), for example its own microcontroller 102, transceiver component 106 negotiates symmetrical keys which are then utilized for the cryptographic authentication and encryption. This is implemented, for example, as an additional function in the additional function device.

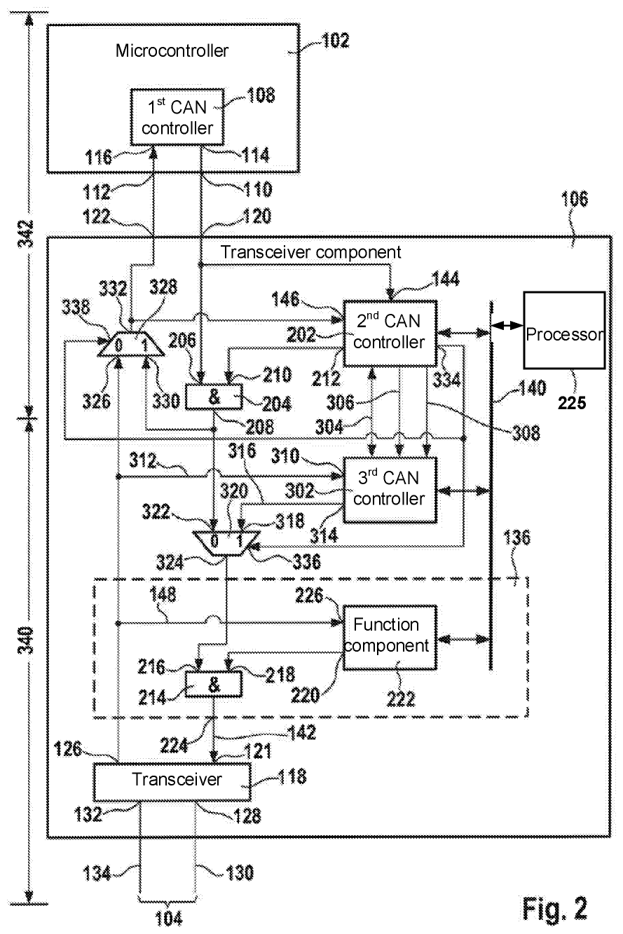

FIG. 2 schematically shows portions of a second embodiment of the interface between microcontroller 102 and transceiver component 106. Elements in FIG. 2 that are the same as the elements from FIG. 1 are denoted by the same reference numerals in FIG. 2.

In addition to the first embodiment of the interface, in the second embodiment of the interface a second transceiver bus controller 302 is provided in transceiver component 106.

First transceiver bus controller 202 and second transceiver bus controller 302 are connected to each other via a first signal interface 304, error/overload, a second signal interface 306, sync_bit, and a third signal interface 308, Tx_ena. First signal interface 304 is used for bidirectional exchange of error information. Second signal interface 306 is used for transferring synchronization information from first transceiver bus controller 202 to second transceiver bus controller 302. Third signal interface 308 is used for transferring a control signal from first transceiver bus controller 202 to second transceiver bus controller 302. This is described below.

Second transceiver bus controller 302 is connected to system bus 140, and is controllable by processor 225 via system bus 140. A third communication input 310 of second transceiver bus controller 302 is connected to second output 126 of transceiver 118 via a third electrical line 312. A second communication output 314 of second transceiver bus controller 302 is connected to a fifth signal input 318 of a third logic component 320 via a fourth electrical line 316. Third logic component 320 is a first multiplexer 320, for example, and is referred to below as first multiplexer 320.

In contrast to the first embodiment of the interface, in the second embodiment of the interface, first signal output 208 is instead connected to third signal input 216 via a sixth signal input 322 of first multiplexer 320. In contrast to the first embodiment of the interface, in the second embodiment of the interface, a third signal output 324 of first multiplexer 320 is connected to third signal input 216 of second AND gate 214.

In contrast to the first embodiment of the interface, in the second embodiment of the interface, second output 126 is instead connected to first output 126 via a seventh signal input 326 of a fourth logic component 328. In the example, fourth logic component 328 is a second multiplexer 328 and is referred to below as second multiplexer 328. In the second embodiment of the interface, an eighth signal input 330 of second multiplexer 328 is connected to first signal output 208 of first AND gate 204. In contrast to the first embodiment of the interface, in the second embodiment of the interface, a fourth signal output 332 of second multiplexer 328 is connected to first output 122.

First multiplexer 320 is designed to switch either only fifth signal input 318 or only sixth signal input 322 to third signal output 324 as a function of a control signal sel_secure.

Second multiplexer 328 is designed to switch either only seventh signal input 326 or only eighth signal input 330 to fourth signal output 332 as a function of control signal sel_secure.

First transceiver bus controller 202 includes a control output 334, which via control lines is connected to a first control input 336 of first multiplexer 320 and to a second control input 338 of second multiplexer 338.

First transceiver bus controller 202 is designed to generate control signal sel_secure as described below, and to control first multiplexer 320 and second multiplexer 328 as described below.

In the example, second transceiver bus controller 302 is a third CAN controller that is designed to operate according to the ISO 11898-1:2015 standard. The first CAN controller, the second CAN controller, and the third CAN controller are also designed to implement the communication method described below.

Protection of Information that is Exchanged Between Transceiver Component 106 and Microcontroller 102

An aim of the communication method described below is to protect the information, exchanged between transceiver component 106 and microcontroller 102, from other bus users on an external bus 340.

As illustrated in FIG. 2, external bus 340 includes second transceiver bus controller 302, transceiver 118, and additional function device 136. An internal bus 342 includes bus controller 108 and first transceiver bus controller 202.

Possible variants are provided as follows:

Variant 1: Transceiver component 106 and microcontroller 102 encrypt the communication, using cryptographic methods. For example, transceiver component 106 as well as microcontroller 102 additionally contain a plug-and-secure communication for CAN module.

In this case, transceiver component 106 and microcontroller 102 establish a symmetrical key and use it for the encryption.

If no plug-and-secure communication for CAN module is contained in microcontroller 102, the key is, for example, transferred into transceiver component 106 beforehand. This is possible, for example, in a secure environment at the end of the assembly line during manufacture.

Variant 2: Transceiver component 106 transmits the KF with a changed data field on external CAN Bus.

When microcontroller 102 or transceiver component 106 transmits a KF, transceiver component 106 relays this KF with changed data to the CAN bus, which is connected to first contact 128 and second contact 132. The relayed frame is denoted by reference symbol WF below.

Only transceiver component 106 and the microcontroller are able to read the original data of the KF. Attention should be paid to the following aspects.

The KF and the WF must have equal lengths so that the start of the subsequent frame can be reliably recognized. The actual length of a frame is a function of the transmitted data, since the CAN protocol provides so-called dynamically inserted stuff bits for the synchronization.

Ensuring that the KF and the WF have the same length can be carried out via different methods, depending on the CAN frame format.

CAN FD frames: in this case, the length of the CRC field is constant, since fixed stuff bits are used. For this purpose, for encoding of the data field, microcontroller 102 can use a method that generates no, or a fixed number of, dynamic stuff bits. Thus, the length of the data field is also constant and is known in advance.

Classical CAN frames: in this case, the length of the CRC field can change due to dynamic stuff bits. To solve this problem, prior to the transfer of the frame, microcontroller 102 computes the number of stuff bits in the data field and the CRC field as a function of the data, and transmits this number to the beginning of the data field. For the remainder of the data field, transceiver component 106 selects a data bit pattern from a prepared list, which generates the same number of stuff bits in the relayed frame.

Alternatively, the contents of the data field can be limited to a selection of bit patterns having uniform lengths for the data field and the CRC field.

The transfer of frames via internal bus 342 and external bus 340 must be kept synchronous.

Transceiver component 106 ensures that the internal communication and the external communication remain synchronous during the transfer of a KF and a WF. This means that when the CAN protocol detects an error on the internal bus or the external bus, internal bus 342 and external bus 340 are once again connected to a CAN bus. This means that a CAN error frame will reach all nodes on the bus. The same applies for overload frames and any other responses of the CAN protocol according to ISO 11898-1:2015.

First signal interface 304, error/overload, is used for transmitting the error or for overload detection. Second signal interface signal interface 306, sync_bit, is used to keep external bus 340 and internal bus 342 synchronous. Third signal interface 308, Tx_ena is used to enable the transmission on internal bus 342 when internal bus 342 and external bus 340 are separated, or to halt the transmission on internal bus 342 when internal bus 342 and external bus 340 are connected. Control signal sel_secure is used to selectively separate or connect internal bus 342 and external bus 340.

An example is described below, with reference to FIG. 2, in which transceiver component 106 includes a plug-and-secure for CAN module as an additional function and a protective function for the data of the KFs.

Transceiver component 106 communicates with microcontroller 102 via CAN frames. This example encompasses the protective function for the data that are exchanged between microcontroller 102 and transceiver component 106. This means that the data are not visible at external CAN bus 340.

First CAN controller 114, second CAN controller 202, third CAN controller 302, and additional function device 136 are equivalent nodes on the same CAN bus, the same as all nodes connected to the external portion of the CAN bus, outside the transceiver component 106.

Second CAN controller 202 takes over the communication with first CAN controller 114, and using the sel_secure signal divides the CAN bus into the two portions internal bus 342 and external bus 340, in the event that the communication between microcontroller 102 and transceiver component 106 is to be masked by other CAN nodes.

In the example, the division of the CAN bus begins with detection of a KFID, and ends with the completion of a transfer of the data frame, or the detection of an error during the transfer (bit error, CRC error, . . . ).

If a CAN error condition (a bit error, for example) has been recognized by third CAN controller 302, this information is immediately signaled to second CAN controller 202 via first signal interface 304 using the error signal. Second CAN controller 202 responds by discontinuing the division, setting sel_secure=0, and starting with sending the error frame in the subsequent bit. All nodes are thus immediately informed.

When microcontroller 102 transmits a KF, the two buses (internal/external) could temporally drift apart due to the clock tolerances allowed with CAN. To prevent this, second CAN controller 202 signals information concerning the beginning/end of the received bit to second CAN controller 302 using the sync_bit signal. Third CAN controller 302 synchronizes the beginning and end of its transmitted bits with the sync_bit signal. The two buses are thus bit-synchronous.

When transceiver component 106 transmits a KF, second CAN controller 202 and third CAN controller 302 are to use the same clock pulse. This implicitly prevents the buses (internal/external) from drifting apart.

Third CAN controller 302 advantageously transmits random or predetermined data in the WF. These data are visible on external bus 340. They mask the data that are exchanged by second CAN controller 202 and first CAN controller 108.

Third CAN controller 302 begins with the data transfer, for example, as soon as third CAN controller 302 is prompted by second CAN controller 202 using the TX_ena signal. This data transfer begins within a CAN frame after the KFID has been recognized.

Processor 225 is designed, for example, to successively configure various typical bit rates (500 kbit/s, for example) in the second CAN controller and to test whether valid CAN messages are recognized.

The CAN transceiver is implemented according to ISO 11898-2, for example.

For start-up, second CAN controller 202 and third CAN controller 302 each enable their TX signal only when they have detected the BT configuration that is used on the bus. During the BT detection, transceiver component 106 behaves like a conventional CAN transceiver, for example.

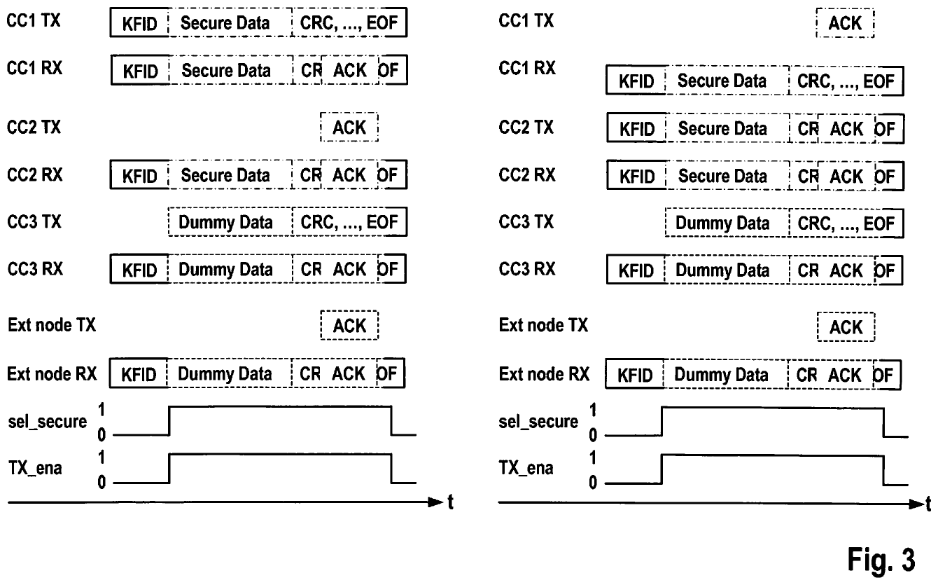

FIG. 3 schematically illustrates a signal-time diagram for the second embodiment of the interface. In the time sequence, the RX/TX signals for all nodes, represented by solid lines, are visible; RX/TX signals represented by dashed lines are visible only on external bus 340; and RX/TX signals represented by dash-dotted lines are visible only on internal bus 342.

The left section of FIG. 3 illustrates the case that first CAN controller 108 transmits a frame together with a KFID. The right section of FIG. 3 illustrates the case that second CAN controller 202 transmits a frame together with a KFID. The bottom section of FIG. 3 illustrates control signals sel_secure and TX_ena, which control the time sequence. In FIG. 3, reference symbol CC1 denotes the first CAN controller. In FIG. 3, reference symbol CC2 denotes the second CAN controller. In FIG. 3, reference symbol CC3 denotes the third CAN controller.

Data that are protected due to the division into internal bus 342 and external bus 340 are denoted as “Secure Data” in FIG. 3. Random data for masking are denoted as “Dummy Data.” External nodes are denoted as “Ext node.” Signals transmitted from a node are denoted by reference symbol TX, and signals received by a node are denoted by reference symbol RX.

The time sequence is as follows:

Left side of FIG. 3:

Microcontroller 102 transmits a frame together with a KFID via CC0. CC1, CC2, CC3, and Ext node simultaneously receive the ID (KFID here) of the frame. The control signal is sel_secure, while sel_secure=TX_ena=0; i.e., there is only a single, shared CAN bus. After the ID of the CAN frame is completely transmitted, CC2 202 detects that CC1 108 has transmitted a frame together with a KFID. CC2 202 then sets sel_secure=TX_ena=1. sel_secure remains set until the data and the CRC of the frame are transmitted from CC1 108. “sel_secure=1” means that the CAN bus is divided into an internal bus 342 and an external bus 340. While sel_secure=1, CC3 302 transmits dummy data and the associated CRC to external CAN bus 340. After the acknowledge bit of the CAN frame, sel_secure=0 is set, and the division into the internal bus and the external bus is discontinued. The Ext node receives this frame together with dummy data, and thus learns nothing of the secure data, and acknowledges the receipt of the frame together with dummy data by transmitting ACK.

Right side of FIG. 3:

Transceiver component 106 transmits a frame together with a KFID via CC2 202. As soon as the ID of the frame is transmitted, sel_secure=1 is set in order to divide the CAN bus into an internal bus 342 and an external bus 340. While sel_secure=1, CC3 302, as in the case on the right side of FIG. 3, now transfers dummy data and the associated CRC to external CAN bus 340, while CC2 202 transfers the secure data to internal CAN bus 342. After the ACK of the frame, sel_secure=0 is set, and the division into two buses is discontinued.

1-15. (canceled)

16. A transceiver component comprising:
a first input;
a first output;
a transceiver;
a functional device; and
a first transceiver bus controller;
wherein:
the transceiver is configured to:
at least intermittently receive output data from a first pin of a microcontroller via the first input of the transceiver component according to a transfer protocol and transmit the received output data via a data bus; and
at least intermittently receive input data from the data bus and transmit the received input data to a second pin of the microcontroller via the first output of the transceiver component according to the transfer protocol;
the transceiver component is configured to at least intermittently:
receive, via the first input and according to the transfer protocol, additional data, which the functional device is configured to use to execute a function; and/or
transmit the additional data via the first output and according to the transfer protocol; and
the first transceiver bus controller includes:
a first communication input that is connectable to an output of the transceiver for receiving the additional data; and/or
a first communication output for transmitting the additional data that is connectable to an input of the transceiver.

17. The transceiver component of claim 16, wherein the first transceiver bus controller includes a second communication input that is connectable to the first input of the transceiver component for authenticating the microcontroller.

18. The transceiver component of claim 16, wherein the transceiver component is configured to receive a first message containing an identifier, store the received identifier in a nonvolatile memory, read the stored identifier from the nonvolatile memory, and transmit a second message, containing the read identifier, on the data bus.

19. The transceiver component of claim 16, wherein the transceiver component is configured to generate an identifier and transmit the identifier in a first message on the data bus.

20. The transceiver component of claim 16, wherein the transceiver component is configured to:
exchange a symmetrical cryptographic key with the microcontroller or a node on the data bus; and
use the symmetrical cryptographic key for a cryptographic authentication or encryption of at least one message to be transmitted, and/or for a cryptographic authentication or decryption of at least one received message.

21. The transceiver component of claim 16, further comprising:
a second transceiver bus controller; and
a first logic component;
wherein:
the second bus controller is configured to transmit at least one message or partial message according to the transfer protocol via the data bus;
the first logic component is configured to selectively allow or prevent a transfer of the additional data or the at least one message or partial message on an external data bus;
the first transceiver bus controller is configured to control the second transceiver bus controller and/or the first logic component in order to at least intermittently transmit the at least one message or partial message on the external data bus, while the first transceiver bus controller receives the additional data via the first input or transmits the additional data via the first output.

22. The transceiver component of claim 21, further comprising:
a second logic component, wherein:
the second logic components is configured to selectively allow or prevent a transfer of the input data or the additional data at the first output; and
the first transceiver bus controller is configured to control the second logic component in order to transfer either the input data or the additional data.

23. A communication method comprising:
a transceiver at least intermittently receiving output data from a first pin of a microcontroller via a first input of the transceiver component according to a transfer protocol and transmitting the received output data via a data bus;
the transceiver at least intermittently receiving input data from the data bus and transmitting the received input data to a second pin of the microcontroller via a first output of the transceiver component according to the transfer protocol;
at least intermittently:
receiving, via the first input and according to the transfer protocol, additional data, which a functional device of the transceiver component is configured to use to execute a function; and/or
transmitting the additional data via the first output and according to the transfer protocol; and
at least intermittently connecting:
a first communication input of a first transceiver bus controller to an output of the transceiver for receiving the additional data; and/or
a first communication output of the first transceiver bus controller to a second input of the transceiver for transmitting the additional data.

24. The method of claim 23, wherein a second communication input of the first transceiver bus controller for authenticating the microcontroller is connected to the first input.

25. The method of claim 23, further comprising:
receiving a first message containing an identifier;
storing the identifier in a nonvolatile memory;
reading the stored identifier from the nonvolatile memory; and
transmitting a second message containing the read identifier on the data bus.

26. The method of claim 23, further comprising:
generating an identifier; and
transmitting the identifier in a message on the data bus.

27. The method of claim 23, further comprising:
exchanging a symmetrical cryptographic key with the microcontroller or another node on the data bus;
using the symmetrical cryptographic key for:
a cryptographic authentication or encryption of at least one message to be transmitted; and/or
a cryptographic authentication and decryption of at least one received message.

28. The method of claim 23, further comprising:
transmitting at least one message or partial message via according to the transfer protocol an external data bus that is external to the transceiver component;
selectively making possible a transfer of the additional data or of the at least one message or partial message on the external data bus;
at least intermittently transmitting the at least one message or partial message on the external data bus, while the additional data are received via the first input or transmitted via the first output.

29. The method of claim 28, wherein either the input data or the additional data are selectively transferred at the first output.

30. A non-transitory computer-readable medium on which are stored instructions that are executable by a processor and that, when executed by the processor, cause the processor to perform a communication method, the method comprising:
at least intermittently receiving, using a transceiver, output data from a first pin of a microcontroller via a first input of the transceiver component according to a transfer protocol and transmitting the received output data via a data bus;
at least intermittently receiving, using the transceiver, input data from the data bus and transmitting the received input data to a second pin of the microcontroller via a first output of the transceiver component according to the transfer protocol;
at least intermittently:
receiving, via the first input and according to the transfer protocol, additional data, which a functional device of the transceiver component is configured to use to execute a function; and/or
transmitting the additional data via the first output and according to the transfer protocol; and
at least intermittently connecting:
a first communication input of a first transceiver bus controller to an output of the transceiver for receiving the additional data; and/or
a first communication output of the first transceiver bus controller to a second input of the transceiver for transmitting the additional data.
